(19) United States
(12) Patent Application Publication
(10) Pub. No.: US 2015/0154600 A1
(43) Pub. Date: Jun. 4, 2015

(54) Method and Apparatus for Risk Identification and Mitigation

(71) Applicant: Moneygram International, Inc., Minneapolis, MN (US)

(72) Inventors: Kristine Marie Diehl, Plano, TX (US); Laura Beth Rau, Frisco, TX (US); Mohamed Adnan Elkadri, Frisco, TX (US); Jeremy Wayne Colvin, Providence Village, TX (US); Alexis Mary Shupak, Frisco, TX (US); Lisa Marie Szatkiewicz, Irving, TX (US); Patricia Anne Hooker, Frisco, TX (US)

(21) Appl. No.: 14/097,032

(22) Filed: Dec. 4, 2013

(51) Int. Cl. G06Q 20/40; G06Q 20/10

(52) U.S. Cl. CPC G06Q 20/4016; G06Q 20/10

(57) ABSTRACT

Systems and methods provide for monitoring, determining, and processing risk indicators relating to a network and/or a consumer. Primary risk indicators may be determined that include measurable metrics of changes in consumer complaint data, e.g. fraud complaint volume or a change in volume with respect to other factors such as number of agents, transactions, and the like. Secondary and/or tertiary risk factors may also be determined, e.g. changes in network such as an increase in the number of agents, total transactions, metrics regarding agent training, trends in particular areas, changes in regulations, etc. With these primary and secondary metrics, systems and methods may monitor these metrics and provide statistical data regarding potential fraudulent activity or other loss data. Upon observing that risk indicators are beyond a pre-determined threshold, systems may determine and/or implement loss prevention measures throughout the network or in targeted areas of the network.

### TECHNICAL FIELD

The present application relates to money transfer transactions, and more specifically to systems and methods for monitoring risks and mitigating risks in a transaction network.

### BACKGROUND

Generally speaking, money transfers are real-time transactions in that a transaction begins when a sender initiates the transaction at the time the money is to be sent to a receiving party. For example, a money transfer may be utilized in an emergency setting such as when a receiving party has an immediate need for funds. In such a transaction, a sender initiates a money transfer transaction with a money transfer service, such as with a local agent located within a MoneyGram® location. When the transaction information is gathered and the structure of the transaction is finalized, the sender provides the funds to a money transfer agent at or before the time that the funds of the transaction are actually transferred.

Once the funds are received at the time of the transaction, the agent may then provide a transaction code or some other form of transaction identifier to the sender. The sender will then provide the transaction code or identifier to the receiver. With this code the receiver may enter an agent location and complete the transaction and receive the transferred funds.

For a money transfer service, conducting a money transfer transaction efficiently and mitigating losses due to fraud, inefficiency, or any other reason is a primary concern. Such mitigation techniques may be implemented on a network basis and/or on an individual consumer basis. As money transfer networks can be large global networks with thousands of customers and agents in a large amount of countries, many risks may be present which can potentially cause a transaction to be fraudulent or to be inefficiently handled in a manner which creates loss for the money transfer company. Often times, the discovery that a risk even exists is a difficult task due to the size of the network and the various parties involved. Additionally, as fraudulent activity becomes more sophisticated, current loss prevention approaches that tend to look at single factors in a vacuum (whether analyzing risk for a particular consumer in a transaction, or analyzing potential problems within a network) become less successful in adequately discovering whether a risk is present. Further, implementation of a loss prevention strategy may also become difficult to implement in a portion or all of a money transfer network.

### BRIEF SUMMARY

The present application provides for systems and methods which provide for monitoring, determining, processing risk indicators, and mitigating risks for a money transfer network. In one embodiment, primary risk indicators corresponding to a network may be determined. Such primary risk indicators may include measurable metrics of changes in consumer complaint data, e.g. fraud complaint volume or a change in volume with respect to other factors such as number of agents, transactions, and the like. Secondary and/or tertiary risk factors may also be determined, e.g. changes in network such as an increase in the number of agents, total transactions, metrics regarding agent training, trends in particular areas, changes in regulations, etc. With these primary and secondary metrics, systems and methods may monitor these metrics and provide statistical data regarding potential fraudulent activity or other loss data. Such monitoring may include gathering data regarding particular areas of the network or particular corridors where risks are present. Upon observing that risk indicators are beyond a pre-determined threshold, systems may determine and/or implement loss prevention measures throughout the network or in targeted areas of the network.

In accordance with one embodiment a method is provided for mitigating loss risk in a transaction network. The method includes compiling, by at least one processing device, risk data from a plurality of sources. Additionally, the method includes producing, by at least one processing device, at least one primary and at least one secondary risk indicator from the compiled data. Further, the method includes determining one or more risk trends based on the produced risk indicators.

In accordance with another embodiment a method is provided for mitigating loss risk in a transaction network. The method includes compiling transaction risk data in a money transfer network by a central server. Additionally, the method includes determining, by at least one processing device in the money transfer network, a plurality of risk factors based on the compiled risk data and calculating, by the at least one processing device, risk trends based on at least one of transaction location and transaction corridor. Further, the method includes upon a risk trend exceeding a pre-determined risk threshold, implementing a risk mitigation procedure in the money transfer network in a location corresponding to at least one transaction location and transaction corridor.

In accordance with another embodiment, a system may include at least one processor configured to compile risk data from a plurality of sources in a network. Further, the processor(s) may be configured to produce at least one primary and at least one secondary risk indicator from the compiled data and determine one or more risk trends based on the produced risk indicators.

One or more embodiments may also be directed toward monitoring, determining, and processing risk indicators associated with a consumer utilizing a money transfer system. In one embodiment, primary risk indicators corresponding to a network may be determined. Such primary risk indicators may include information relating to a consumer, such as consistency of consumer provided data, types/amounts of transactions, frequency of transactions, geographical considerations of transferring party and receiving party, number of receiving parties, and the like. With these indicators, systems and methods may monitor and process statistical data regarding potential fraudulent for the consumer. Upon observing that risk indicators are beyond a pre-determined threshold, systems may determine and/or implement loss prevention measures directed toward the consumer to mitigate the potential for loss.

In accordance with one embodiment a system and method are provided for mitigating loss risk in a transaction network. The system and method include compiling, by a central server, a plurality of types of transaction risk data relating to a consumer initiating a money transfer transaction in a money transfer network, and using the process device to weight the data and compare the plurality of types of transaction data to one more key risk indicator thresholds. The system and method further include calculating the consumer risk level that corresponds to a risk level for the consumer utilizing the weighted risk data and threshold comparisons and determine whether risk mitigation actions are needed determining one or more risk trends based on the produced risk indicators.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 illustrates a financial transaction computing network in accordance with an embodiment of the present application;

FIG. 2 illustrates a functional block diagram for mitigating risk in a money transfer system in accordance with an embodiment of the present application;

FIG. 3 illustrates a functional block diagram for mitigating risk based on a consumer using a money transfer system in accordance with an embodiment of the present application;

FIGS. 4A-4B illustrates an example consumer risk ranking model in accordance with an embodiment of the present application;

FIG. 5 illustrates a illustrates a method for performing risk mitigation within a transaction network in accordance with an embodiment of the present application;

FIG. 6 illustrates a method for performing risk mitigation within a transaction network in accordance with an embodiment of the present application; and

FIG. 7 illustrates a method for performing risk mitigation based on a consumer implementing a transaction within a transaction network accordance with an embodiment of the present application.

### DETAILED DESCRIPTION

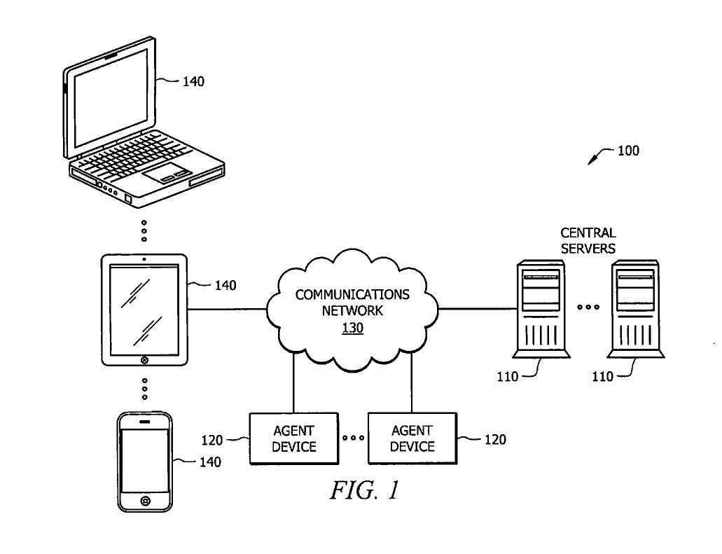

FIG. 1 illustrates a financial transaction computing network 100 in accordance with an embodiment of the present application. Financial transaction computing network 100 may include one or more central servers 110. Central servers 110 correspond to a central or parent entity which administers money transfer transactions between agent devices 120. Central servers 110 may be commonly located or distributed geographically. Additionally, the administration of a money transfer transaction and/or the configuration of one or more agent devices 120 may be implemented by a single server, or by using multiple processing resources of a plurality of servers.

Financial transaction computing network 100 further includes a communication network 130. Communication network 130 may include any type of network which allows for communication between central servers 110 and agent devices 120. For example, communication network 130 may comprise the Internet, WiFi, mobile communications networks such as GSM, CDMA, 3G/4G, WiMax, LTE, and the like. Further, communications network 130 may comprise a combination of network types working collectively.

Agent devices 120 correspond to one or more computing devices which are disposed at an agent location of a money transfer service. Such computing devices are configured with sufficient processing resources, memory, communications capabilities, and the like, to implement the functionality described herein. It is noted that in some embodiments an agent may have multiple devices at a particular location. Further, while only a small number of agent devices 120 are shown for the sake of simplicity, it is contemplated that financial transaction computing network 100 may include a very large number of agent devices 120 which are located worldwide. In some instances, multiple agent devices 120 may correspond to a particular chain of locations owned by an agent, while in other instances, an agent may have only a single location.

In some instances, particular groupings of agent devices 120 may be administered to by a pre-determined central server 110. Such a relationship may be established based on physical proximity of the devices and/or based on capabilities of the devices, e.g. processing resources, bandwidth availability, and the like. In other instances agent devices 120 may be administered to by a central server 110 based on other considerations, such as communication availability, processing resources, etc.

Central server 110 may be configured to compile information from one or more agent devices 120, user devices 140, or other central servers 110 relating to transactions and other administrative data in the network. For example, central server 110 may compile information regarding primary and/or secondary risk indicators. Further, central server 110 may process data and make determinations regarding whether observed risks should be addressed with a corrective action. If such a determination is made, central server 110 may distribute/implement loss prevention policies within the network. Such observations, determinations, and implementation of policies are discussed in more detail below.

Network 100 may also include one or more user devices 140. User devices 140 may be any type of device which would facilitate the exchange of information within system 100. For example, user devices 140 may include computer systems, tablet devices, mobile telephones, and the like. Different embodiments may utilize different aspects of the types of client devices. For example, mobile telephones and tablet devices may have the ability to connect with various communications networks and may have different application execution capabilities. User devices 140 may be utilized before, during and after a money transfer transaction in any manner to facilitate convenient and secure transactions.

For example, a sending party may initiate a money transfer transaction from a user device 140 via an online connection or a dedicated application. The user device may communicate with one or more of central server 110 or an agent device 120 to initiate a transaction for a pre-specified amount of funds. The send transaction may be completed using user device 140 (similar to how an agent device 120 would function), or a transaction may be staged or partly staged at the user device and the details may be later provided to an agent device 120 for completion of the transaction.

On the receiving side, a receiving party using user device 140 may be notified of a money transfer transaction via an online application, dedicated application, email, text, etc. Such a communication may direct the receiving party to a receiving agent location where the transferred funds may be paid.

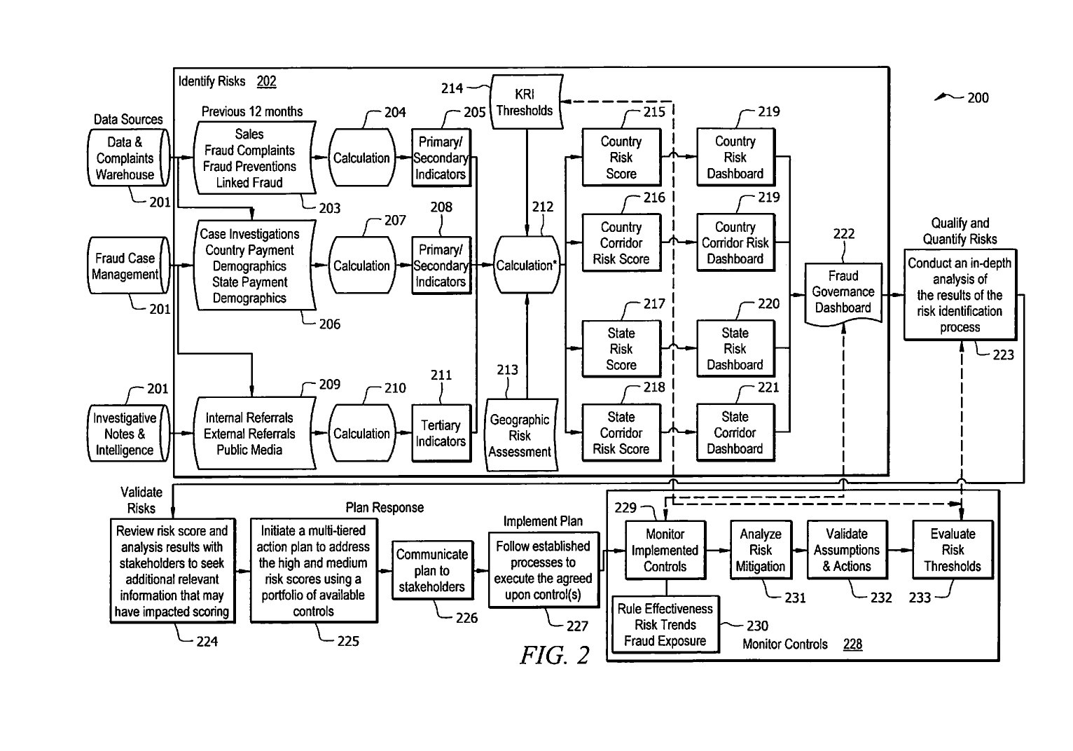

FIG. 2 illustrates a functional block diagram for a risk-based identification of compliance and fraud prevention/mitigation system 200 in accordance with an embodiment of the present application. System 200 generally accounts for risks that are more network-based in nature (as opposed to consumer-based) which monitors/analyzes risks based on actions within a network. This system may be implemented within system 100 described above. Further, data sources which provide information, devices that make risk determinations, and devices that implement mitigation plans may include further processing devices outside of system 100. One of skill in the art would readily understand that devices which provide relevant information and/or provide processing capabilities may be added to system 100 where applicable depending on the type of data needed within the system.

System 200 includes a plurality of data sources 201 which provide risk data to risk identification processing block 202. Data sources 201 may provide any data which is useful to compile risk information from any relevant source. For example, data source 201 may comprise a complaints warehouse source. This source may include data which is compiled when a consumer calls into a customer service center or reports a complaint at an agent location. Such a complaint yields a significant amount of data regarding a transaction. For example, data regarding transacting parties, transaction amounts, source and destination information of the transaction, type of payment used in the transaction, etc., may be compiled by this data source. Such data may be classified in a manner that provides primary and secondary indicator data.

In one embodiment, data source 201 may also include a source from a fraud case management system. When fraudulent activity is investigated, data derived from such an investigation may be placed in a case management system. Such data may include information compiled/collected regarding fraud cases, e.g. locations or common locations between multiple cases, other demographic information relating to fraudulent activity, and the like. The investigative notes and intelligence source 201 may also include information from internal or external sources that may be obtained in the course of a fraud investigation. External information (e.g. fraud data information from third party regulators, law enforcement, media, etc.) will generally provide tertiary or secondary risk information.

The source data from 201 is provided to risk identification processing block 202. In one embodiment, processing of risk may include analyzing the previous twelve months of sales data and fraud complaints, along with actual prevention data at 203. Linked fraud data may also be analyzed at 203 which includes information where consumers have complained about being defrauded and additional consumer transactions that appear to be linked to that same fraudulent activity. With this data, a calculation 204 may be implemented that provides primary key risk indicators 205.

Table 1 illustrates possible key risk indicators in accordance with one aspect of the present application.

TABLE 1

| | Primary Indicators: Driven by measureable changes in consumer |
|---|---|
| KRI # | complaint data |
| KRI 1.1 | Consumer Fraud Complaint Volume: Ratio of agent location |
| | consumer fraud complaints to total receive transactions |
| | (items or dollars) |
| KRI 1.2 | Volume of fraud complaints increased greater than or equal |
| | to X % |
| KRI 1.3 | Value of fraud complaints increased greater than or equal |
| | to X % |
| KRI 1.4 | Fraud to sales value ratio greater than or equal to X % |
| KRI 1.5 | Fraud to sales volume ratio greater than or equal to X % |
| KRI 1.6 | Fraud complaint volume for an Agent is greater than or |
| | equal to X % of total country fraud |
| KRI 1.7 | Fraud complaint value for an Agent is greater than or |
| | equal to X % of total country fraud |

As can be seen in the above example, primary indicators 205 may include indicators relating to receive location versus total receive transactions; volume increase of fraud complaints (e.g. relative with respect to a predetermined variable x); value (or increase of value) of fraud complaints; fraud to sales value ratio; fraud to sales volume ratio; fraud complaint volume for an agent with respect to total location (e.g. country) fraud; and fraud complaint value for a particular agent with respect to total location fraud. Such indicator values may be relative values with respect to a pre-determined unit X %. For example, the volume of fraud complaints alone may not be indicative of a risk which warrants a corrective action, however, a substantial increase in fraud complaints may be more indicative of a larger problem.

In one embodiment, processing of risk may also include analyzing fraud case management data 206. Case management data may include any information from case investigations, data regarding location of origin/destination of transactions, location demographics, payment discrepancy information (e.g. wrongful payout data), etc. This information may be linked to other relevant data or combined to provide stronger fraud indications. For example, when a consumer complaint is present along with a payment discrepancy, the likelihood of fraudulent activity is increased. It is appreciated that multiple data points may be linked when investigating fraud. Case management data 206 is then processed/calculated at 207 to provide additional (or secondary) key risk indicators 208.

Table 2 illustrates possible secondary risk indicators in accordance with one aspect of the present application.

TABLE 2

| | Secondary Indicators: Driven by measurable changes in |
|---|---|
| KRI # | consumer complaint data |
| KRI 2.1 | # of Agent locations increased greater than or equal to X |
| | in country |
| KRI 2.2 | # of Agent training for fraud increased greater than or |
| | equal to X % in specific country |
| KRI 2.3 | # of Agent restrictions for fraud increased greater than or |
| | equal to X % in specific country |
| KRI 2.4 | # of Agent suspensions for fraud increased greater than or |
| | equal to X % in a specific country |
| KRI 2.5 | # of Agent terminations for fraud increased greater than or |
| | equal to X % in a specific country |
| KRI 2.6 | Effectiveness for existing rule is greater than or equal to X % |
| KRI 2.7 | Average fraud transaction greater than or equal to $ X.XX |
| KRI 2.8 | Average fraud transaction increased greater than or equal to |
| | X % |
| KRI 2.9 | Fraud to sales value ratio increased greater than or equal to |
| | X % |
| KRI 2.10 | Fraud to sales volume ratio increased greater than or equal to |
| | X % |

As can be seen in the above example table, secondary indicators 208 may include indicators relating to whether the number of agent locations have increased appreciably in a particular area or country; the number of agent training, restrictions, suspensions, and/or terminations for fraud has increased appreciably in a particular area or country; the effectiveness for an existing rule/procedure is greater than a pre-determined metric; the average fraud transaction is greater than a particular amount; the average fraud transaction had increased by an appreciable percentage; and fraud to sales value and/or volume ratios have increased by an appreciable amount.

In one embodiment, processing of risk may also include analyzing investigative and intelligence data 209. For example, tertiary indicators of fraud may be determined/calculated at 210 based on third party referrals, public media sources, or any other available data. The result of this analysis may provide tertiary indicators that may be helpful for loss prevention.

Table 3 illustrates possible tertiary risk indicators in accordance with one aspect of the present application.

TABLE 3

| | Tertiary Indicators: Driven by feedback from industry, |
|---|---|
| KRI # | regulatory and law enforcement communities |
| KRI 3.1 | Feedback from internal line of business sources |
| KRI 3.2 | Feedback from Agents during a program review or |
| | compliance discussion |
| KRI 3.3 | Feedback on new/emerging trends from industry partners |
| KRI 3.4 | Feedback on new/emerging trends from regulators |
| KRI 3.5 | Feedback on new/emerging trends from law enforcement |
| | (discussion or subpoena) |

The example tertiary indicators may include feedback from internal business sources or from agents; and feedback from industry partners, regulators and/or law enforcement regarding emerging trends. Such feedback may provide helpful indications, especially when viewed in the context of primary and secondary indicators.

With indicators 205, 208 and 211, the data may be provided to a calculation block 212. This calculation may also include geographic risk assessment data 213 (e.g. data that provides information regarding countries/states that are high risk for fraud) and key risk indicator threshold data 214. The resulting values from this calculation may provide one or more of a send score, receive score, and a deviation score which indicates the likelihood of fraudulent activity being present.

A country risk score 215, country corridor risk score 216, state/municipality risk score 217, and state/municipality corridor risk score 218 may then be determined based on the calculations at 212. Country risk score 215 may provide data regarding one or more of send and receive risk scores sorted by country. Such data may provide indications as to whether one country is worse from a risk standpoint than another. It is appreciated that countries may be more prone to be send countries, while others may primarily be receive countries. The country risk score may be utilized to create a heat risk model at country risk dashboard 219 which can distinguish countries by high, medium and low risk. In other words, risk exposure may be categorized into levels. Such levels may be useful when determining whether/how to implement future mitigation remedies. Further, a heat risk model may provide data as to how the risk factors are trending (e.g. over the past 12 months).

The country corridor risk score 216 and country corridor dashboard 219 analyzes the corridors or paths of transactions between countries. For example, if a money transfer transaction is sent from the United States to Mexico, a corridor between these countries is defined. Understanding the flow of a transaction is helpful as often times fraudulent transactions follow similar corridors. Further, if particular corridors are recognized as risk-prone, various controls along those corridors may be implemented. It is appreciated that a large money transfer service may service 30,000+ corridors between countries. As such, narrowing particular corridors of interest may be a great assistance in mitigating fraud and loss.

In some embodiments, a state risk score 217 and dashboard 220 may be provided. The state risk score 217 and dashboard 220 may function similar to country risk score 215 and dashboard 219. However, it is appreciated that transfers may be intra country (e.g. within the United States) and monitoring activity between states may be useful. It is further noted that while this embodiment utilizes the term “state” other smaller entities such as cities, municipalities, etc. may be monitored likewise. Likewise state corridor scores 218 and corresponding dashboard 221 may be implemented in a similar manner with respect to country corridor score/dashboard, based on smaller regions.

All of the risk/corridor information may be provided to fraud governance dashboard 222. Fraud governance dashboard 222 may assist a money transfer organization in deciding how to address various fraud situations.

With the risk data compiled, processed, and various risk factors determined, embodiments may then function to qualify and quantify the risks at 223. This may include conducting an in-depth analysis of the results of the risk identification process to further define risks and to provide information regarding the occurrences of these risks. Embodiments may also include a validation step 224 where these results are checked against any other additional relevant information for the sake of preserving accuracy. Such a validation may be done by individuals at a money transfer service, or may be done automatically based on pre-defined metrics that results can be compared to, corrected against, etc.

With the risk data completely quantified, in the event that particular risks are determined that need to be addressed, embodiments may begin planning possible responses at steps 225 and 226. Such planning may include determining what types of actions may be needed to address a particular risk. For example, if fraudulent activity appears to be concentrated in a particular area, an action plan may include implementing one or more training procedures for agents in the particular area and/or placing restrictions on certain types of transactions in that area, corridor, etc. Such an action plan may be determined automatically by system 200 (or within system 100) based on pre-determined actions (e.g. training plans or other pre-arranged action plans may be automatically provided for when one or more risk factors are prevalent). Conversely, risk factors may be provided to a representative of a company for planning and approval of a course of action. Further, in some instances a combination of automatic and manual actions may be implemented.

With an action plan in place, system 200 may then implement the plan at 227. Implementation of a plan may include sending instructions from a central server to one or more agent devices which execute various controls/processes designed to mitigate risk. For example, training sessions may be sent to agents in a money transfer network. Additionally, in the event that an action plan requires certain types of transactions will be limited or to require additional information in order to establish the transaction, a central server may update software at a local device, or provide mid-transaction instructions directly, that alters the flow of the transaction in order to implement the action plan.

Embodiments may also include a monitoring block 228 which includes one or more processes that may monitor the implementation and effectiveness of a risk mitigation plan. For example, implemented controls may be monitored at 229. Such controls may be monitored in light of any effectiveness data or new trends 230 which may be provided by risk identification block 202. Data from this monitoring may be utilized to analyze risk mitigation 231 and to validate assumptions regarding risks and/or action plans 232. Further, monitoring block 228 may include a process which evaluates risk thresholds 233 to insure that the utilized thresholds are at effective levels, e.g. whether exceeding a threshold actually is indicative of a risk, whether a threshold should be lower, etc.

It is appreciated that the system of FIG. 2 is discussed by way of example and one or more blocks, risk factor types, etc., may be omitted and/or added. More specifically, there are multiple ways to implements a risk management/mitigation method within system 100 which monitors one or more primary, secondary, and/or tertiary risk indicators, process the indicators (e.g. align/determine country/state/corridor data with factors) in a manner to calculate and provide data that may be utilized to establish an action plan, and to implement the established plan.

For the sake of understanding, example situations are provided which illustrate how embodiments of a risk mitigation system/method may be implemented to compensate for risks in a transaction network.

In this example case, one or more new agents have been established in a particular area. Shortly after the launch of these agents, system 200 may receive an increased number of fraud complaints. In another case, a fraud ring has begun operating in a state in the United States. Shortly after the fraud ring started targeting consumers, system 200 may receive an increased number of fraud complaints for that state. This increase in complaints may or may not exceed a threshold to create an action plan to mitigate risks. However, trends in these complaints may provide insight that fraudulent activity may be experiencing an uptick in a particular area. Secondary and/or tertiary information may also be received that support these trends. For example, information from regulators or competitors regarding various issues, in conjunction with the increase in complaints may trigger a system to start some amount of preventative measures to mitigate risk (e.g. provide marketing/consumer information regarding risks, provide training to an agent, etc.). As such, systems and methods may begin risk mitigation based on a statistical analysis of a plurality of risk factors at an earlier point in time (such as before fraudulent activity becomes widespread).

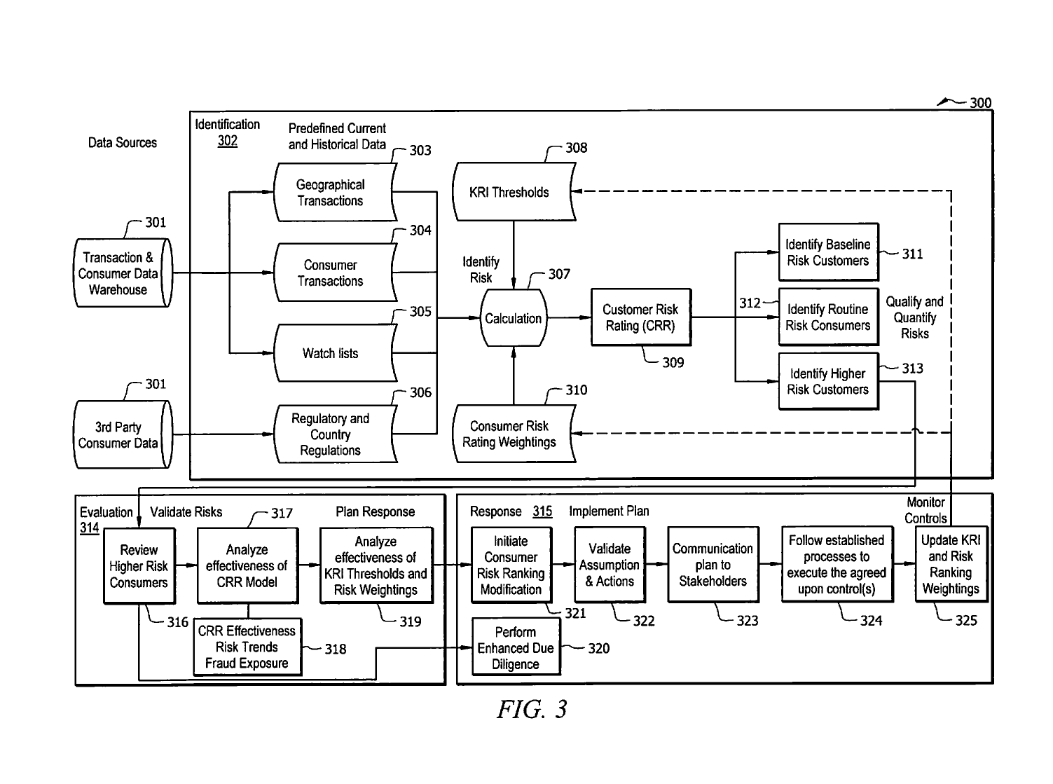

FIG. 3 illustrates a functional block diagram for a risk-based identification of compliance and fraud prevention/mitigation system 300 in accordance with an embodiment of the present application. System 300 generally accounts for risks that are more consumer-based in nature (as opposed to network-based) which monitors/analyzes risks based on actions of a particular consumer within a network. This system may be implemented within system 100 described above. Further, data sources which provide information, devices that make risk determinations, and devices that implement mitigation plans may include further processing devices outside of system 100. One of skill in the art would readily understand that devices which provide relevant information and/or provide processing capabilities may be added to system 100 where applicable depending on the type of data needed within the system.

System 300 includes a plurality of data sources 301 which provide risk data to risk identification processing block 302. Data sources 301 may provide any data which is useful to compile risk information from any relevant source. For example, data source 301 may comprise a transaction and consumer data warehouse source. This source may include data which is compiled corresponding to a consumer, such as transaction information, location/geographical information and/or any other useful consumer information which is relevant to consumer risk.

It is appreciated that such data may be provided in various forms. For example, geographical data may include consumer data provided with respect to a typical consumer. In some areas a typical consumer may implement only 1-2 transactions a year to 1-2 different locations. Conversely, other areas may have typical consumers that initiate more transactions that are sent to more or less differing areas. Accordingly, consumer risk models may vary based on geographic locations and deviations from that model may be compared for a consumer in a particular area. Profiles of individual consumers may also be provided which take into account actions of the particular consumer (e.g. indicating how many transactions, types of transactions, locations, identification used, etc., for the consumer). Watch list data may also be provided such as from financial crimes enforcement divisions within respective jurisdictions, and the like. Such data may be classified in a manner that it provides primary and secondary indicator data.

In one embodiment, data source 301 may also include third party consumer data sources which may provide information relating to a consumer. For example, if the consumer is constrained by any regulatory concerns of a particular jurisdiction, such information may be provided by an entity in the jurisdiction.

The source data from 301 is provided to risk identification processing block 302. In one embodiment, different information is split among geographical transaction information 303, consumer transaction information 304, watch list information 305 and regulatory information 306. This data may be sent (or weighted and then sent) to calculation block 307. At calculation block 307, the input source date is compared to one or more key risk indicator thresholds 308 which are indicative of threshold values for consumer-based risk assessment. For example, if a consumer has a certain percentage of volume over a typical volume for a country, such a factor would be taken into account for calculating a consumer risk ranking (CRR) at block 308.

Consumer risk ranking may provide an indication of the level of risk for a particular consumer. It is appreciated that a CRR may be divided into multiple levels or provided a score value. Such a score may take into account a weighted average of the various identified risk factors and compare to the key risk indicator thresholds to determine the amount or level where a consumer is scored. Weighting values may be provided to calculation block 307 by consumer risk weighting block 310.

An example calculation at calculation block 307 may include receiving data from geographical transaction block 303 and consumer transaction block 304. The information from geographical transaction block may be more relevant to potential risk and may therefore be given a higher weight-value when considering risk. Further, the weights assigned to the risk identification information may also be modified based on the level that a specified activity surpasses a threshold. For example, if watch list information from a particular source is not normally given a high weighting, but the amount of watch list issues significantly surpasses a key risk indicator threshold (e.g. is at a higher level of risk), information from this source may be analyzed with a higher weighting. A weighted average of the received information may be compared to the key risk indicator thresholds. Alternatively, the separate information may be compared to different thresholds and threshold scores may then be weighted.

Embodiments may also compare or multiply a resulting value with a modifier which may account for divergence in current data with respect to previous consumer data. For example, in the event that a consumer has been transacting a certain amount of business in a geographical area and the number or value of the transactions undergoes an increase, the divergence of this activity may be utilized for risk analysis.

Based on the CRR of a particular consumer, the consumer may be classified into one or more classifications. Specifically a consumer may be considered a baseline risk consumer 311, routine risk consumer 312 or high risk consumer 313. In the event that a high risk consumer is identified, system 300 may implement one or more risk mitigation plans which are formulated in evaluation block 314 and/or response block 315. Evaluation block 314 may evaluate model parameters such as by reviewing the higher risk consumer 316, analyzing the effectiveness of the CRR score 317, effectiveness of risk trends 318 and the effectiveness of the key risk indicator thresholds 319.

Response block 315 may be utilized to implement additional due diligence for a consumer 320 and/or to implement a response plan for a given risk mitigation task. Additional due diligence from a mitigation plan may include gathering additional information from a consumer, or about a consumer. For example, additional validation of identification provided by the consumer may be implemented with one or more third parties, etc. Additional information may also be requested from the consumer at the point of a transaction.

Response block 315 may be further utilized to evaluate and modify the response plan for high risk consumers 321. This may include, at 322, validating whether various assumptions regarding risk are useful and whether actions taken to mitigate risks have been helpful. Further, risk mitigation plans may be communicated to one or more administrators 323 and additional instructions may be received at 324. Further, updates of key risk indicator data, risk weightings, and/or other data utilized for calculation block 307 such as divergence modifiers and the like may be determined at block 325 and provided to identification block 302.

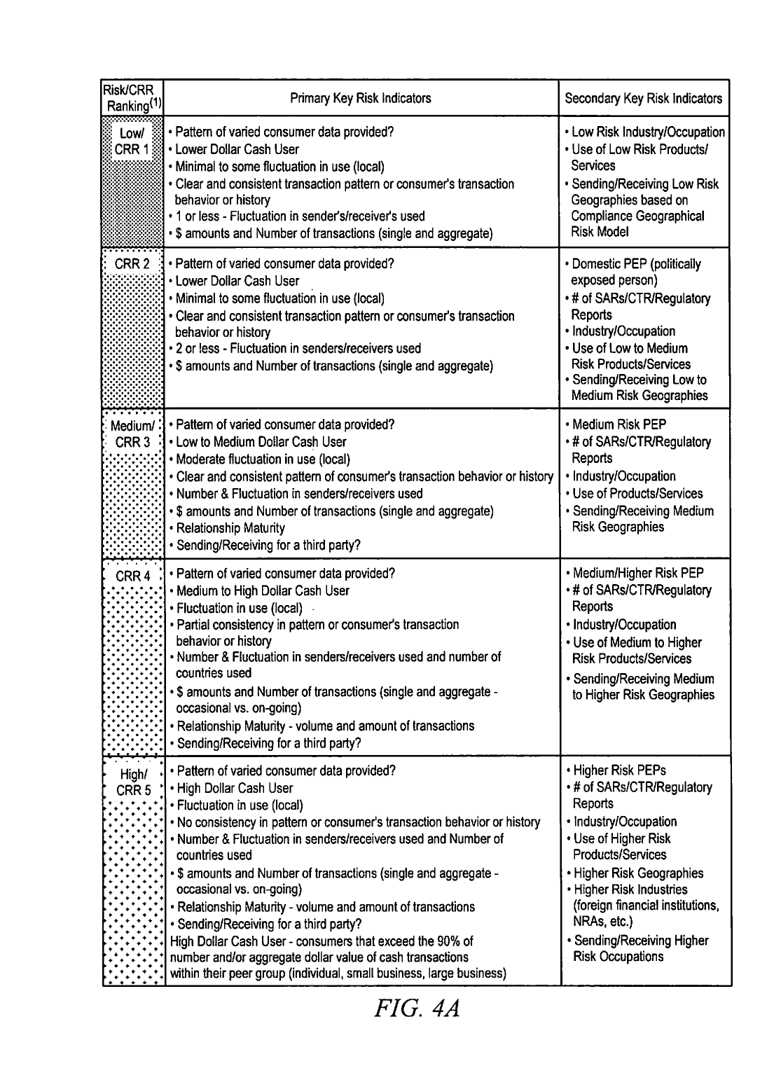

FIGS. 4A-B illustrates an example consumer risk ranking model which provides for primary and secondary key risk indicators with respect to various risk levels/CRR scores 400 and example planned response actions with respect to the risk levels/CRRs 401 in accordance with an embodiment. Model 400 includes risk level classifications and/or CRR ranking scores based on various observed primary and secondary key indicators. Model 400 further includes potential planned responses based on the risk level. It is appreciated that the amount and type of risk levels may be customized according to various needs. Further, primary and secondary indicators of fraud may be deemed as more or less serious based on various situations.

Primary risk indicators may include information regarding the consumer such as whether the consumer has provided differing consumer data (where differing data may be indicative of heightened risk), the amount of the transaction, transaction patterns and frequency, and the like. Some of this information may be geographically dependent (e.g. a high frequency of transaction may be high with respect to a particular area). A lower risk transaction may be present when lower dollar amounts are used, frequency of transactions are normal, receiving parties are stable, etc. Conversely, a higher risk may be present when inconsistent data is provided, high dollar amounts are utilized, frequency of transactions are inconsistent, etc.

Secondary key risk indicators may include one or more of information regarding whether the product or service being used is risky, whether an individual (sender or receiver) is well known or politically connected, geographic factors, etc. Such factors are discussed in model 400.

A planned response is provided in model 400 which outlines possible courses of action to take with respect to a consumer at the various risk levels. As can be seen, at a low risk, baseline diligence may be implemented, whereas at medium ranges additional consumer information may be desired. Further, at high risk levels, additional controls at an agent may be implemented (e.g. require a consumer to further identify themselves, provide additional data, etc.).

Example situations are also provided which illustrate how embodiments of a risk mitigation system/method may be implemented with respect to mitigating risk at the consumer level.

A consumer that transfers money on a regular bases may have money transfer transaction patterns shift in one or more of the number of receiving parties that they are sending to, the countries they are sending to and the dollar amount of transactions sent. Shortly after the transactional shift, system 300 may identify the consumer as a higher risk consumer and initiate an investigation into the consumer's activity for potential risks. Enhanced due diligence of the consumer may be conducted in accordance at 320 (FIG. 3) which may initiate additional risk mitigation process.

In another example, a new sending party may send a money transfer transaction through an agent location. System 300 identifies the consumer as being a potential high risk Politically Exposed Person (PEP). The consumer is escalated for enhanced review and enhanced due diligence, in accordance at 320 (FIG. 3) to validate the consumer through review and possibly third party validation, which may initiate additional risk mitigation processes.

As can be seen by the above examples, systems and methods may implement a coordinated risk approach that considers multiple variables together. Further, action plans may be implemented across a global network or in specifically targeted areas based on the statistical determinations regarding risk factors.

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

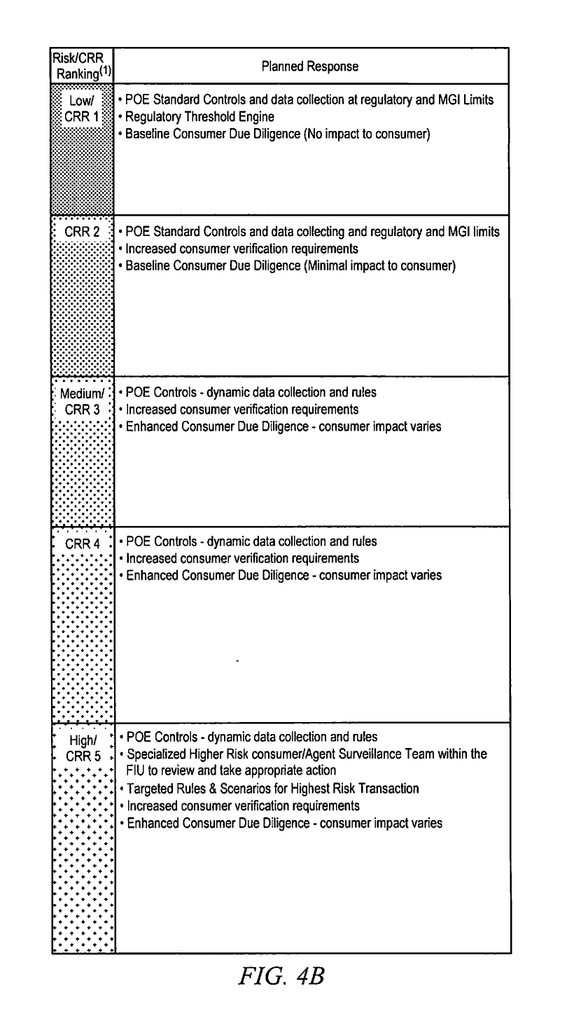

FIG. 5 illustrates a method 500 for performing risk mitigation within a transaction network in accordance with an embodiment of the present application. It is noted that method 500 may be implemented within one or more systems, such as systems 100 and 200 described above. Method 500 includes, at block 501, compiling, by at least one processing device, risk data from a plurality of sources. As described above, sources of risk data may be any sources that may yield relevant data. For example, risk data may be compiled from agent devices in a network, from consumer complaints that are provided to an agent or to a central location, from third party sources, etc.

Method 500 includes, at block 502, producing, by said at least one processing device, at least one primary and at least one secondary risk indicator from the compiled data. As described above, primary risk indicators may include data regarding specific transactions that have occurred and appear to be fraudulent. This data may be broken down and processed to provide further information such as the volume of fraudulent transactions compared to the total volume for an agent/area/location. The actual transaction values may also be compared. Fraud complaint volumes may also be analyzed and taken into account.

Secondary risk indicators may include information regarding changes in the network such as an increase in the number of agent locations in the network, information regarding training activity for the agents, or other useful information regarding agent activities. Information regarding existing mitigation techniques may also be measured/provided as a secondary indicator. Further, in some aspects tertiary indicators may also be produced which utilize information derived from various sources reporting on external conditions which are relevant to the potential for fraud in a given situation.

Method 500 includes, at block 503, determining one or more risk trends based on the produced risk indicators. Such trends may be broken down by locations, corridors and the like. Determining risk trends may include analyzing current data and comparing it to threshold data or previous data. Further, trends may be categorized into levels of risk (e.g. low/medium/high). With these trends, a determination as to whether risk mitigation procedure are needed may be made. Additionally, embodiments may include implementing at least one risk mitigation procedure within a network.

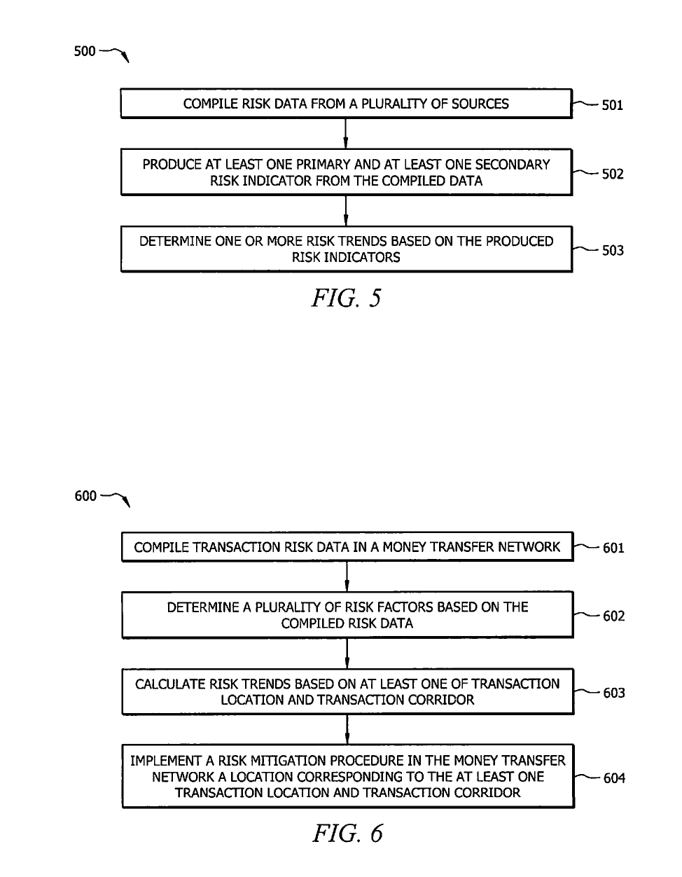

FIG. 6 illustrates a method 600 for performing risk mitigation within a transaction network accordance with an embodiment of the present application. It is noted that method 600 may be implemented within one or more systems, such as systems 100 and 200 described above. Method 600 includes, at block 601, compiling transaction risk data in a money transfer network by a central server. As with the above method, sources of risk data may be any sources that may yield relevant data. For example, risk data may be compiled from agent devices in a network, from consumer complaints that are provided to an agent or to a central location, from third party sources, etc.

Method 600 includes, at block 602, determining a plurality of risk factors based on the compiled risk data. Such risk factors may include primary, secondary and tertiary risk indicators as described above. Method 600 also includes, at block 603, calculating risk trends based on at least one of transaction location and transaction corridor. Such calculations may be implemented as described above with respect to system 200. It is noted that risk trends may be calculated based on risk indicator observations that are compared to individual threshold values to observe trends. Alternatively, risk indicator calculations may be compiled into a trend that is compared to a trend threshold to provide a variance with respect to a normal trend. Any such value may be utilized for risk mitigation.

Upon a risk trend exceeding a pre-determined risk threshold, method 600 further includes, at block 604, implementing a risk mitigation procedure in the money transfer network a location corresponding to the at least one transaction location and transaction corridor. Implementing a risk mitigation procedure may include any action which is directed to account for observed trends and attempt to prevent fraudulent activity. For example, to implement a risk mitigation procedure, a central server in a money transfer network may distribute training materials to specific agents or agent devices. A mitigation procedure may also include other steps such as altering a transaction flow (e.g. requiring further information/authentication for a transaction and the like) for at least one agent device in a the location corresponding to an area where the risk trend exceeds a pre-determined risk threshold.

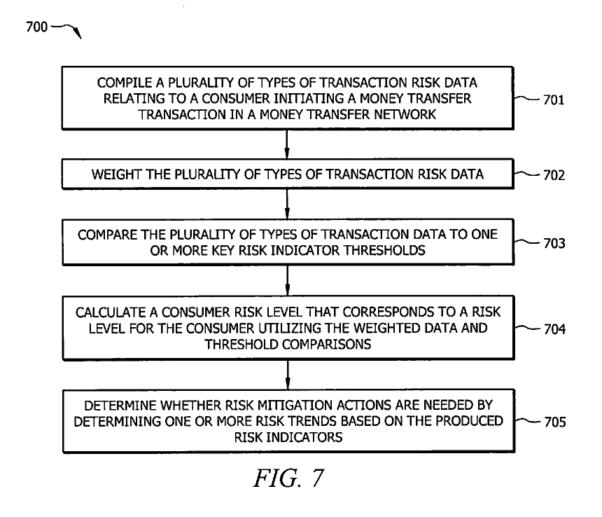

FIG. 7 illustrates a method 700 for performing risk mitigation based on a consumer implementing a transaction within a transaction network accordance with an embodiment of the present application. It is noted that method 700 may be implemented within one or more systems, such as systems 100 and 300 described above. Method 700 includes, at block 701, compiling, by a central server, a plurality of types of transaction risk data relating to a consumer initiating a money transfer transaction in a money transfer network. Such transaction risk data may come from data sources (e.g. data sources 301) which provide consumer-based information for analysis. Method 700 may further include, at 702, weighting, by at least one processing device, the plurality of types of transaction risk data.

Method 700 may include, at 703, comparing, by at least one processing device, the plurality of types of transaction data to one or more key risk indicator thresholds. Further method 700 may include at step 704, calculating a consumer risk level that corresponds to a risk level for the consumer utilizing the weighted risk data and threshold comparisons, and at 705 determining whether risk mitigation actions are needed determining one or more risk trends based on the produced risk indicators.

It is noted that the functional blocks and modules in FIGS. 1-7 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for mitigating loss risk in a transaction network, the method comprising:
compiling, by at least one processing device, risk data from a plurality of sources;
producing, by said at least one processing device, at least one primary and at least one secondary risk indicator from the compiled data;
comparing, by said processing device, at least one of the produced risk indicators to a threshold value;
determining one or more risk trends based on the compared risk indicators and threshold values; and
determining whether risk mitigation actions are needed for the transaction network based on the one or more risk trends.

2. The method of claim 1 wherein the determining one or more risk trends includes compiling location data for the produced risk indicators and correlating the location data with the produced risk indicator data.

3. The method of claim 1 wherein the determining one or more risk trends includes compiling corridor data for the produced risk indicators and correlating the corridor data with the produced risk indicator data.

4. The method of claim 1 wherein the at least one primary indicator produced includes an indicator corresponding to a value representing at least one of a: receive location fraud complaints versus total receive transactions for the location; volume increase of fraud complaints; monetary value of fraud complaints; fraud value to sales value ratio; fraud volume to sales volume ratio; fraud complaint volume for an agent at a location with respect to total location fraud; and fraud complaint value for a particular agent in a location with respect to total location fraud.

5. The method of claim 4 wherein the at least one secondary indicator produced includes an indicator corresponding to a value representing at least one of an: increase in agent locations in a particular area, agent training data, agent restriction data, agent suspension data, agent termination data, effectiveness for an existing rule/procedure with respect to a pre-determined metric, increase in the average fraud transaction value, and increase in fraud to sales value and/or volume ratio.

6. The method of claim 5 further comprising producing at least one tertiary risk indicator and determining one or more risk trends based on the produced primary, secondary and tertiary risk indicators.

7. The method of claim 1 wherein the at least one primary indicator is derived from data relating to specific fraudulent transactions.

8. The method of claim 7 wherein the at least one secondary indicator is derived from agent device setup data.

9. The method of claim 8 further comprising producing at least one tertiary risk indicators wherein the at least one secondary indicator is derived from feedback data regarding external conditions.

10. The method of claim 1 further comprising automatically determining whether to implement a risk mitigation procedure based on determined risk trends.

11. A system comprising:
at least one processor configured to:
compile risk data from a plurality of sources in a network;
produce at least one primary and at least one secondary risk indicator from the compiled data;
determine one or more risk trends based on the produced risk indicators; and
compare at least one of the produced risk indicators or the one or more risk trends to a threshold value; and
determine whether risk mitigation actions are needed for the transaction network based on the threshold comparison.

12. The system of claim 11 wherein the at least one primary indicator is derived from data relating to specific fraudulent transactions.

13. The system of claim 12 wherein the at least one secondary indicator is derived from agent device setup data.

14. The system of claim 13 wherein the at least one processor is further configured to produce at least one tertiary risk indicators wherein the at least one secondary indicator is derived from feedback data regarding external conditions.

15. The system of claim 11 wherein the at least one processor is further configured to receive a risk mitigation procedure having policies to implement in response to a determined risk trend.

16. The system of claim 11 wherein the at least one processor is further configured to implement at least one risk mitigation procedure in the network.

17. A method comprising:
compiling transaction risk data in a money transfer network by a central server;
determining, by at least one processing device in the money transfer network, a plurality of risk factors based on the compiled risk data;
calculating, by the at least one processing device, risk trends based on at least one of transaction location and transaction corridor; and
upon a risk trend exceeding a pre-determined risk threshold, implementing a risk mitigation procedure in the money transfer network a location corresponding to the at least one transaction location and transaction corridor.

18. The method of claim 17 wherein the risk mitigation procedure includes altering a transaction flow for an at least one agent device in a the location corresponding to an area where the risk trend exceeds a pre-determined risk threshold.

19. The method of claim 18 wherein the altered transaction flow includes requiring additional authentication data for a money transfer transaction.

20. The method of claim 17 wherein said compiling transaction risk data includes compiling data corresponding to fraudulent transaction complaints and location data.

21. The method of claim 20 wherein said compiling transaction risk data includes compiling data corresponding to network activity of the money transfer network.

22. A method comprising:
compiling, by a central server, a plurality of types of transaction risk data relating to a consumer initiating a money transfer transaction in a money transfer network;
weighting, by at least one processing device, the plurality of types of transaction risk data;
comparing, by the at least one processing device, the plurality of types of transaction data to one or more key risk indicator thresholds;
calculating a consumer risk level that corresponds to a risk level for the consumer utilizing the weighted risk data and threshold comparisons; and
determining whether risk mitigation actions are needed determining one or more risk trends based on the produced risk indicators.

23. The method of claim 22 wherein said calculating a consumer risk level includes utilizing a divergence factor to compare divergence of the compiled data with previously compiled data relating to the consumer.

24. The method of claim 22 further comprising altering the weighting for the plurality of types of transaction risk data based on the amount that a particular type of data exceeds a key risk indicator threshold.

25. The method of claim 22 wherein the plurality of types of transaction data includes geographic-based consumer data which compares a consumer to a typical consumer for a geographical area.

26. The method of claim 22 wherein the one or more key risk indicator thresholds include a threshold that corresponds to an amount of variance of consumer identification data with respect to previously received data.

27. The method of claim 22 wherein the one or more key risk indicator thresholds include a threshold that corresponds to typical geographical limits for a consumer transaction.

28. A system comprising:
at least one processing device configured to:
compile a plurality of types of transaction risk data relating to a consumer initiating a money transfer transaction in a money transfer network;
weight the plurality of types of transaction risk data;
compare the plurality of types of transaction data to one or more key risk indicator thresholds;
calculate a consumer risk level that corresponds to a risk level for the consumer utilizing the weighted risk data and threshold comparisons; and
determine whether risk mitigation actions are needed determining one or more risk trends based on the produced risk indicators.

29. The system of claim 28 wherein calculating a consumer risk level includes utilizing a divergence factor to compare divergence of the compiled data with previously compiled data relating to the consumer.

30. The system of claim 28 wherein the at least one processing device is further configured to alter the weighting for the plurality of types of transaction risk data based on the amount that a particular type of data exceeds a key risk indicator threshold.

31. The system of claim 28 wherein the plurality of types of transaction data includes geographic-based consumer data which compares a consumer to a typical consumer for a geographical area.

32. The system of claim 28 wherein the one or more key risk indicator thresholds include a threshold that corresponds to an amount of variance of consumer identification data with respect to previously received data.

33. The system of claim 28 wherein the one or more key risk indicator thresholds include a threshold that corresponds to typical geographical limits for a consumer transaction.

34. The system of claim 28 wherein the at least one processing device is further configured to:
compile risk data from relating to a money transfer network from a plurality of sources;
produce at least one primary and at least one secondary network-based risk indicator from the compiled data;
comparing the at least one of the produced network-based risk indicators to a threshold value; and
determining whether risk mitigation actions are to be implemented for the network.
